(19) United States
(12) Patent Application Publication
(10) Pub. No.: US 2008/0298815 A1
(43) Pub. Date: Dec. 4, 2008

(54) Small Form Pluggable Analog Optical Receiver

(75) Inventors: Ihab E. Khalouf, Allentown, PA (US); Philip Miguelez, Warminster, PA (US); Alfred J. Slowik, Lansdale, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/755,868

(22) Filed: May 31, 2007

(51) Int. Cl. H04B 10/06

(52) U.S. Cl. 398/202

(57) ABSTRACT

A pluggable small form factor optical receiver is described. The optical receiver can be plugged into an optical receiver unit which may hold many optical receivers. The optical receiver includes a photo-detector, a pre-amplification stage, and an attenuator. The optical receiver may have receptacle optical ports such as LC or SC type, also it may include a pin connector for mating with the optical receiver unit and a latch mechanism to secure the optical receiver in the optical receiver unit.

### FIELD OF INVENTION

The present invention relates to an analog optical receiver. More precisely, the present invention relates to a small form factor pluggable analog optical receiver.

### BACKGROUND

Coaxial cable television systems have been in widespread use for many years and extensive networks have been developed. The extensive and complex networks are often difficult for a cable operator to manage and monitor. A typical cable network generally contains a headend which is usually connected to several nodes which provide content to a cable modem termination system (CMTS) containing several receivers, each receiver connects to several modems of many subscribers, e.g., a single receiver may be connected to hundreds of modems. In many instances several nodes may serve a particular area of a town or city.

The hybrid fiber coaxial (HFC) network and CATV market is driving toward highest density transport as well as having flexible capability to transmit and receive QAM signals in a cost effective matter. Multi transmitters and multi receivers, such as quadrature amplitude modulation (QAM) & dense and coarse wavelength division multiplexed (DWDM)& (CWDM) CATV transmitters and receivers, are gathered next to each other, respectively. Each transmitter typically transmits at a specific single wavelength channel of the DWDM, e.g., up to 40 wavelengths on the ITU grid with a 100 Ghz (0.8 nm) spacing. Each receiver also typically receives at a specific single wavelength channel. All these wavelengths typically are combined on a single fiber in order to increase fiber usage and reduce cost.

The typical analog CATV optical receiver is constructed as a single module or circuit board. Each module generally contains a single photo-detector which provides one channel, and as many as 40 channels (e.g. 40 transmitter boards) are provided in a headend unit. A cable operator generally needs to maintain an extra board for each channel to replace a receiver board when it becomes defective or to simply change the channel parameters, such as the frequency. The receiver boards are bulky and expensive, and are often individually built and tuned. Accordingly, what is needed is a small form factor pluggable optical CATV receiver which takes up much less space, can be easily replaced, and is cost effective. Furthermore, with the increasing demand for more data bandwidth to be available to subscribers, many HFC networks are attempting to provide more bandwidth by pushing the optical fiber deeper into the network to bring the point at which the optical communications are converted to RF communications over a coaxial cable closer to the end user. Therefore new cost effective platforms of optical receivers are needed to receive data from remotely located end user subscribers and/or nodes back to the head end unit and vise versa.

### SUMMARY OF THE INVENTION

This invention provides a small form factor analog CATV optical receiver.

In accordance with an apparatus of the invention an optical receiver contained in a housing, the optical receiver may comprise: a photo-detector configured to convert optical signals into electrical signals; an ultra low noise amplifier stage configured to amplify the electrical signals of a desired frequency range; and a digitally controlled precision step attenuator configured to attenuate the amplified electrical signals. The optical receiver may further comprise a microprocessor configured to receive instructions from a host external to the optical receiver and configured to control the attenuator. The optical receiver may further comprise an RF amplifier output stage which is configured to provide gain to the electrical signal. The housing of the optical receiver may include a pin connector which is configured to mate with a pin connector on a host device when the optical receiver is mounted in the host device. The housing may include a latch which is configured to secure the optical receiver when mounted in the host device. The housing may include a handle which is configured to engage and disengage the latch with the host device. The housing may include an optical connector receptacle configured to connect to an optical fiber. The housing may have dimensions of: height at approximately 8.6 mm, width at approximately 13.7 mm, and depth at approximately 56.6 mm.

In accordance the invention, an optical receiver unit in a housing, the optical receiver unit may comprise: a plurality of ports configured to receive an optical receiver in a housing, the optical receiver including: a photo-detector configured to convert optical signals into electrical signals; a trans-impedance amplifier configured to amplify the electrical signals of a desired frequency range; and an attenuator configured to attenuate the amplified electrical signals. The plurality of ports may include more than one port. The optical receiver may include a microprocessor configured to receive instructions from the optical receiver unit and is configured to control the thermo-electric driver and to monitor the input optical signal level. The optical receiver unit may further comprise a pin connector which is configured to mate with a pin connector on the optical receiver. The housing of the optical receiver unit may include a notch which is configured to mate with a latch on the housing of the optical receiver. The housing of the optical receiver may have dimensions of: height at approximately 8.6 mm, width at approximately 13.7 mm, and depth at approximately 56.6 mm.

The small form factor of the optical receiver provides a cost effective solution. Since the operator can densely pack many (e.g. 40) optical channels in a single optical receiver unit, the operator can receive QAM data in a very efficient manner, such as with low cost and high data capacity per chassis volume. The pluggable nature of the optical receiver also allows an operator to easily add, remove and swap one optical receiver for another in event of a desired channel change or a damaged optical receiver by just removing the optical receiver from the host module cages. The invention also allows the operator of the HFC network to combine multiple optical receivers in a smaller host module which resides at the head end or at the hub or at the node to receive data at many different wavelengths from the same host module.

The invention gives the user the flexibility to choose the desired receiver channel (wavelength), distance, and cabling on a port by port basis. The invention provides a cost effective QAM receiver with great operator system control.

### BRIEF DESCRIPTION OF THE DRAWINGS

The following drawings serve to illustrate the principles of the invention.

FIG. 1 illustrates an exemplary network in which the present invention may operate.

FIG. 2 illustrates an optical receiver unit in an exemplary communication system.

FIG. 3 illustrates the usage of SFQP receiver configuration in a host module.

FIG. 4 illustrates a first exemplary configuration of a small form factor pluggable analog optical receiver.

FIG. 5 illustrates a second exemplary configuration of a small form factor pluggable analog optical receiver.

FIG. 6 illustrates a third exemplary configuration of a small form factor pluggable analog optical receiver.

FIG. 7 illustrates a host module with multiple ports, each port may connect to a small form analog optical receiver.

FIG. 8 illustrates a frontal view of an exemplary small form analog optical receiver in accordance with the present invention.

FIG. 9 illustrates a rear view of an exemplary small form analog optical receiver in accordance with the present invention.

### DETAILED DESCRIPTION OF THE INVENTION

The invention provides for a small form pluggable analog optical receiver, which may perform Quadrature Amplitude Modulation (i.e. QAM). The pluggable receiver may plug into ports of a headend host module, nodes in the HFC network, or customer/subscriber premises equipment (CPE), such as set top boxes and modems. The receiver receives an optical QAM data signal through different lengths of optical fiber and converts it into an electrical signal. The small form optical receiver may use the mechanical dimensions of existing components, such as dimensions specified in the multi source agreement of the small form pluggable synchronous optical network (SONET)/synchronous digital hierarchy (SDH) telecom transceivers.

The invention provides capability of receiving QPSK, QAM, and limited analog CATV channel loading at either frequency bands (i.e. for return path 5-200 Mhz and for forward path 50-1000 Mhz) with variety of input optical power level such as −16 to 0 dBm or −6 to +3 dBm with single mode fiber. The invention provides RF amplification for the received optical signal, and digital diagnostics and monitoring for the receiver parameters such as: input received optical power, RF output power level, receiver disable control, and dc power supply. The invention may use a 75 ohm output controlled impedance and have a compact small size (i.e. (H×W×D)=8.6×13.7×56.6 mm) in a shielded metal package that is plugged thru a shielded cage into the host unit to reduce EMI and allow users to stack many receivers as needed next to each other anywhere in the CATV HFC network. The design allows HFC CATV network for further node segmentations and therefore extending the fiber reach deeper to the end user and even to reach to the set top box.

The invention is electrically pluggable to a host unit for easy swapping and the mechanical housing has a front folded colored bail latch for easy mechanical release from the host unit. The invention uses receptacle optical ports (i.e. LC or SC connectors) for easy fiber cabling. The invention is compact in size and has all the electronics needed to receive and condition an adequate QPSK & QAM and limited analog channels loads. The receiver integrates the following components: PIN photo detector integrated in a receiver optical subassembly (ROSA), Trans-impedance amplifier with an automatic gain control function, post amp, and a microcontroller or an analog to digital converter IC chip (i.e. ADC) with an EEPROM for serial ID data, control and monitoring functionality with I2C control.

FIG. 1 illustrates an exemplary network in which the present invention may operate. As illustrated in FIG. 1, an exemplary network may include a plurality of terminal network elements 8 (e.g. cable modems, set top boxes, televisions equipped with set top boxes, or any other element on a network such as an HFC network) connected to a cable modem termination system (CMTS) 10 located in a headend 14 through nodes 12 and one or more taps (not shown). In an exemplary arrangement, headend 14 also contains a plurality of optical transmitters 17 which provide downstream optical communications through an optical fiber to the plurality of nodes 12, and an optical receiver 16 which provides upstream optical communications from nodes 12 to the headend 14. The CMTS 10 connects to an IP or PSTN network 6. Those of skill in the art will appreciate that there may be a plurality of nodes 12 connected to a headend, and a headend may contain a plurality of CMTS units, each of which contain a plurality of RF receivers (e.g. 8 receivers) each of which communicate with the optical transmitters 17 and receivers 16 to communicate with a plurality (e.g. 100 s) of network elements 8. Those of skill in the art will also appreciate that optical transmitters 17 and optical receivers 16 are illustrated separately for discussion purposes and may be integrated into one unit.

As illustrated in FIG. 1, a controller 9 allows an operator to control parameters of optical transmitters 17 and optical receivers 16. The operator may provide instructions to controller 9 through input 15 using any conventional techniques, such as with keyboard 13, remotely through a wireline or wireless interface, or through a removable storage device carrying instructions. Input 15 may also include an Ethernet input which allows a remote operator to provide real-time system monitoring and instructions to controller 9. Preferably, controller 9 is configured to determine or receive parameters associated with optical transmitter 17 and optical receiver 16 and provide the parameters to display 11. The operator may view the current power level of a transmission channel on display 11 and provide instructions to change the power level of a particular channel.

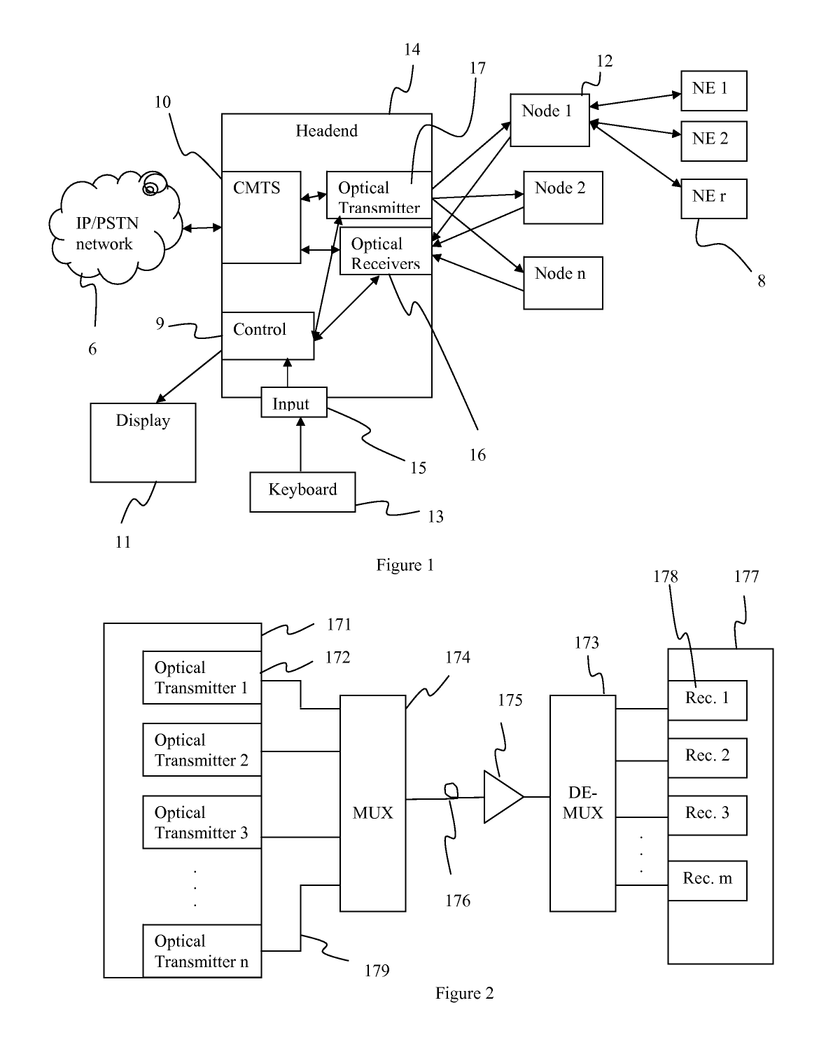

FIG. 2 illustrates a communication path for an optical transmitter unit 171 and an optical receiver unit 177 in an exemplary communication system. Optical transmitters 172 each typically provide an optical signal on separate frequencies (or wavelengths). The plurality of optical signals are combined together by multiplexer 174 to be carried on a single optical fiber 176 to an erbium doped fiber amplifier (EDFA) 175 and a demultiplexer 173, which may be a distance of over 60 Km. Optical receiver unit 177 may be one of several optical receiver units contained in optical receivers 16 of FIG. 1. As illustrated in FIG. 2, optical receiver unit 177 preferably contains a plurality of optical receiver 178, each of which receives an optical signal on a separate frequency (or wavelength) over optical fiber 179 so that each receiver provides a communication channel to a node 12.

Demultiplexer 177 preferably separates the combined optical signals to provide the respective communication channels to optical receivers 178. Those of skill in the art will appreciate that the optical receivers 178 may be contained in nodes 12, at which point the communication channels may be provided as RF communications signals to network element 8. Alternatively, the receivers 178 may be at the user's premises and an optical to RF conversion of the communication channel may occur at the user's premises prior to network element 8 or within network element 8.

FIG. 3 illustrates an exemplary optical receiver unit 177 in greater detail. As illustrated in FIG. 3, optical receiver unit 177 may be in the form of a card which may be inserted in a slot in the headend. Optical receiver unit 177 preferably contains a plurality of optical receivers 178 which receive optical signals from the HFC network, such as upstream signals from users. The optical signals are converted to RF signals by optical receivers 178 and provided to the CMTS as RF signals. A microcontroller 189 preferably provides instructions to RF level control and monitoring circuits 181 to monitor and control the output RF level of the electrical signals from optical receivers 178. Amplifiers 180, such as post drive amplifiers, may be configured to receive the electrical signals from optical receivers 178 and to provide a desired amount of amplification, which may be based on monitoring the RF level at RF monitoring circuits 181. The electrical signals are preferably provided to an output, such as a QAM/RF output 185, and provided to the host unit, such as a headend, a node or a CPE.

An RF switch may be included in RF monitoring circuits 181 to allow an operator to monitor the RF output level for any of the receiver modules 178 via RF test point 183. The RF switch may be firmware controlled. Further, while four receiver modules 178 are illustrated, any number of receiver modules may be present. Those of skill in the art will appreciate that the small form factor of the receiver modules 178 enable an increased density of received input optical channel signals.

The invention preferably utilizes the mechanical dimension of the SFP telecom transceivers specified in the SFP multi source agreement (MSA). The invention will have 20 pin electrical inputs that connect the SFQP to the host module thru the SFP XCVR edge connector.

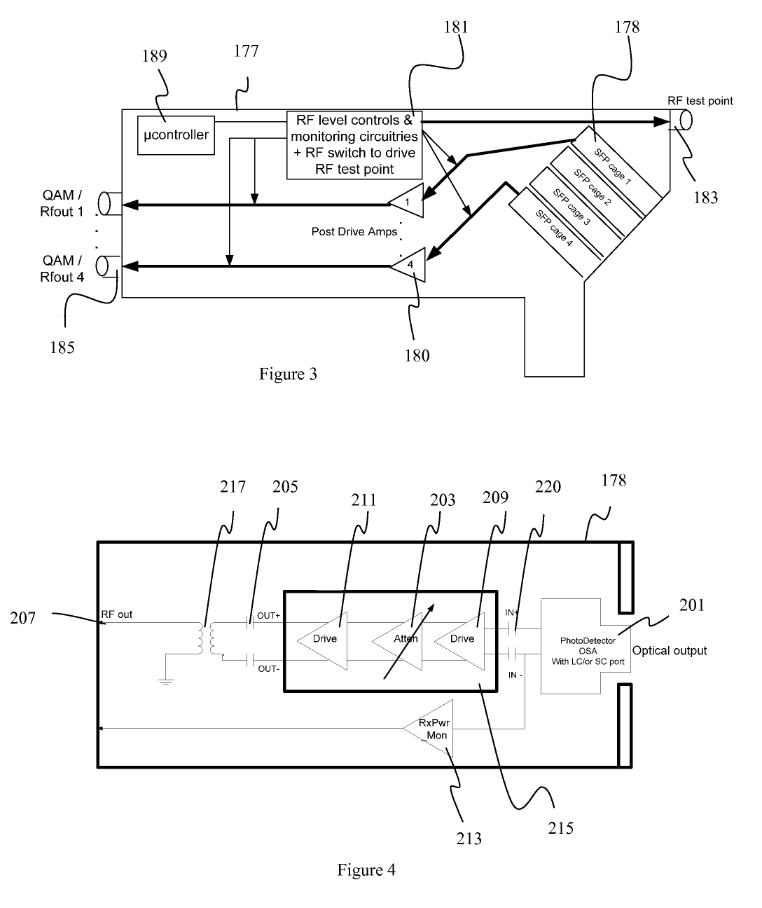

FIGS. 4-6 illustrates exemplary circuits of an optical receiver in accordance with the principles of the invention. The electrical design for this receiver was done by using a receptacle photo-detector followed by a low noise high linearity pre-amplification stage followed by an RF digitally controlled attenuator with an output post amp all integrated into a microwave/millimeter wave monolithic integrated circuit (MIMIC). An example of a suitable MIMIC is model ARA 2004 from Anadigics. A linear trans-impedance amplifier (TIA) may also be used for the first amplification stage.

The preferred implementations also provide a receptacle optical input port with optical return loss better than 27 dB. Other configurations may use pigtail SC/APC connectors. The electrical side (RF output) may also be hot pluggable. A precision attenuator which provides up to 20 dB in 0.5 dB increment via three wire serial interface controlled from the host module may also be used. The receiver 178 preferably meets telecom SFP transceiver MSA package outlines and contains a stand alone IR receiver.

FIG. 4 illustrates a first exemplary design of receiver 178. A receiver optical sub-assembly (ROSA) 201 is configured to receive the optical signals and convert the optical signals to electrical signals. The ROSA 201 preferably contains a photo-detector, and may be a TO-56 metal can ROSA which contains an InGaAs PIN photodetector with cap lens assembled to a receptacle optical port with (LC or SC type). An example of an suitable ROSA is TMC-2C33-001 from TrueLight.

The electrical signals are passed through coupling capacitors 220 to MIMIC 215. MIMIC 215 may be a 28 pin SSOP package and a printed wiring board. MIMIC 215 may contain an ultra low noise amplifier stage 209 which amplifies the electrical signals and a step attenuator 203 which attenuates the electrical signals. Attenuator 203 may be configured from a variable gain control circuit on MIMIC 215 an ADC IC chip I2C control with an EEPROM to monitor input optical power signal level and maintain serial ID information. Another drive amplifier 211 may be used to amplify the signals from attenuator 203 to a desired output level. MIMIC 215 may be controlled by an external controller to control attenuator 203 and amplifiers 209 and 211.

Output coupling circuitry may include capacitors 205 and transformer 217 which provide the electrical signals to 75 ohm match RF output port 207. The received electrical signal power may be monitored at power monitor amplifier 213, which preferably provides the received signal power level to an external controller. This configuration allows users to place their own desired post amplifier on the hosted modules in order to get their desired gain.

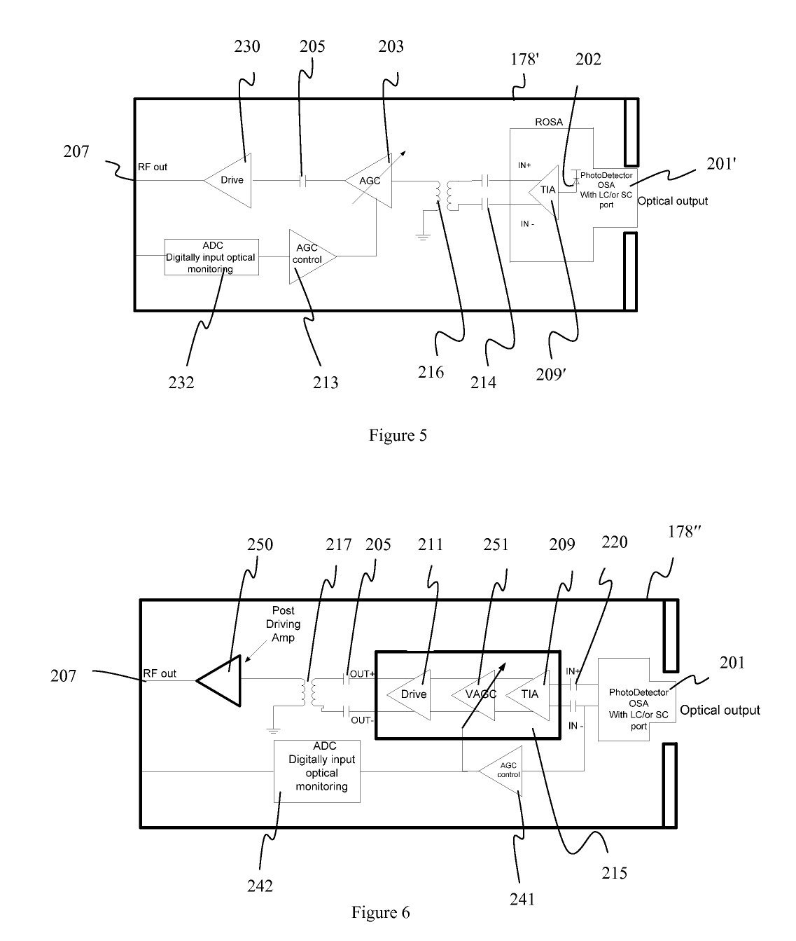

FIG. 5 illustrates another exemplary arrangement for receiver 178. As illustrated in FIG. 5, TIA 209′, a linear trans-impedance amplifier) with high input dynamic range is inserted in ROSA 201′, adjacent to photo-detector 202. Placing TIA 209′ with ROSA 201′ provides improved impedance matching and saves space on a printed wiring board. A coupling circuit, capacitor 214 and transformer 216, provides the electrical signals from ROSA 201′ to attenuator 203, which may be in the form of an AGC. An amplifier drive 230 receives the electrical signals from attenuator 203 via coupling capacitor 205 and provides the electrical signals to RF output 207. Attenuator 203 may be controlled by attenuator/AGC control driver (amplifier) 213 and ADC monitoring circuit 232. ADC monitoring circuit 232 preferably receives instructions from an external controller to control attenuator 203.

FIG. 6 illustrates another exemplary arrangement for receiver 178. As illustrated in FIG. 6, receiver 178″, ROSA 201 provides electrical signals through coupling capacitor 220 to MIMIC 215. TIA 209 receives the electrical signals and provides them to variable automatic gain control (VAGC) 251 which is configured to function as an attenuator. Drive amplifier 211 amplifies the electrical signals and provides them to a post driving amplifier 250, via coupling circuit containing capacitors 205 and transformer 217. Post driving amplifier 250 preferably amplifies the electrical signal to achieve a higher output gain, and provides the electrical signals to RF output 207. Post driving amplifier 250 may be any suitable amplifier, such as CGB 1089z from Sirenza. VAGC 251 may be controlled by AGC control driver (amplifier) 241 and ADC monitoring circuit 242. ADC monitoring circuit 242 preferably receives instructions from an external controller to control VAGC 251.

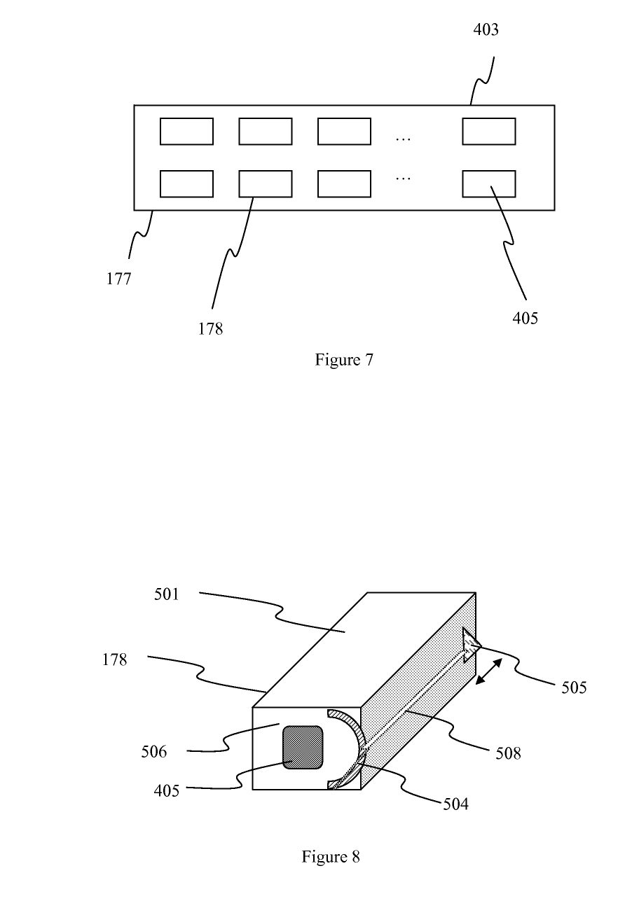

As illustrated in FIGS. 7-9, another feature of the invention is allowing the user to fit many optical receivers 178 on one small receiver unit 177 as a host module (FIG. 7), increasing the ability for segmentation and increasing the receive baud rate of information transmitted through the fiber. As illustrated in FIG. 7, a plurality of optical receivers 178 may be housed in a housing 403 of receiver unit 177 by being inserted into receptacles 405. Housing 403 may be secured to a headend unit 10 by insertion into a slot on headend 14 (not shown). As illustrated in FIG. 7, optical receivers 178 preferably contain a receptacle for easy cabling with fiber optic lines as known to those of skill in the art, such as LC or SC type receptacles, or optical receivers 178 may contain a pig tail optical connector (a short length of optical fiber projecting from it).

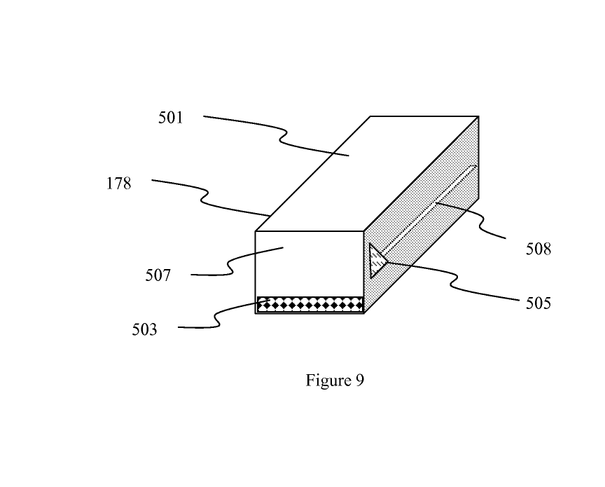

FIG. 8 illustrates a frontal view of optical receiver 178 contained in a housing and FIG. 9 illustrates a rear view of optical receiver 178 contained in a housing. As illustrated in FIGS. 7 and 8, optical receiver 178 is preferably configured in a housing 501 that can be readily inserted and removed in a receptacle in receiver unit 177. In the preferred implementation, optical receiver 178 may be secured when inserted in receiver unit 177 by a bay latch 505 which engages with a notch on the housing of receiver unit 177 (not shown). Bay latch 505 may be actuated in a swinging motion or an in-out motion by an actuator rod 508 which connects to a handle 504, and moves bay latch 505 when handle 504 is moved. Handle 504 may also be used to enable an operator to pull optical receiver 178 out of the receptacle in receiver unit 177. In operation, pressing handle 504 against front face 506 of optical receiver housing 501 preferably engages latch 505 with optical receiver unit housing 403 to securely hold the optical receiver 178. When handle 504 is pulled, such as when the arched end is rotated away from face 506 of housing 501, latch 505 is preferably disengaged, allowing optical receiver 178 to be removed from receiver unit housing 403. While an arched shaped handle is illustrated for discussion purposes, those of skill in the art will recognize that any suitable handle shape may be used, including an irregular shaped handle. A colored bail latch may also be used, with different colors indicating the link length for the receiver and input optical range at which the receiver can operate. Those of skill in the art will appreciate that the invention allows an operator the capability to quickly and easily swap receiver and change receiver channels on a port by port basis.

As illustrated in FIG. 9, a rear face 507 of optical receiver housing 501 preferably contains a pin connector 503 which mates with a pin connector in optical receiver unit housing 403. Pin connector 503 may include a pin connector with any number of pins, such as a 20 pin electrical connector, or may include for example, a SFP XCVR edge connector. Control information, RF data signals and like are preferably provided to the optical receiver 178 from the receiver unit 177 as the host module.

The optical receiver 178, may utilize mechanical dimensions which allow it to utilize existing packages or replace existing structures. For example, the optical receiver 178 may use the dimensions of the SFP telecom transceivers specified in the SFP multi source agreement (MSA), e.g. (H×W×D)=8.6×13.7×56.6 mm. The receiver unit 177, as a host module at the head end could be designed to hold 16, 32, 40, etc. of the optical receiver 178. Those of skill in the art will appreciate that use of a large number of optical receiver 178 in a receiver unit 177 not only uses an operator's available space more efficiently, and makes it more practical for operators to receive multiple return paths and forward paths using a single host module panel that fits the large number of optical receivers 178.

The small form factor of the optical receiver 178 provides a cost effective solution. Since the operator can densely pack more than 40 optical channels in a single optical receiver unit, the operator can receive QAM data in a very efficient matter, such as with low cost and high data capacity per chassis volume and digital diagnostic features that help system and field service equipment engineers to set and maintain the system performance. The pluggable nature of the optical receiver 178 also allows an operator to easily add, remove and swap one optical receiver for another in event of a desired increase receiver density or an optical receiver becomes defective or damaged by just removing the optical receiver from the host module cages. The invention also allows the operator of the HFC network to combine multiple optical receiver in a smaller host module reside at the head end, at the hub, at the node, or at CPE devices to receive data at many different wavelengths from the same host module. The invention also facilitates CATV HFC network node segmentation and hence increasing the delivered bandwidth to the end user.

What is claimed is:

1. An optical receiver comprising:
a housing containing:
a photo-detector configured to convert optical signals received through an optical fiber into electrical signals;
an amplifier stage which receives the electrical signals and amplifies the electrical signals; an attenuator configured to attenuate the amplified electrical signals; and
a pluggable connector configured to provide communications between the receiver and a host device, the communications including the amplified electrical signals.

2. The optical receiver of claim 2, further comprising a microprocessor configured to receive instructions from a host external to the optical receiver and configured to control the attenuator.

3. The optical receiver of claim 1, further comprising an RF amplifier which is configured to provide gain to the electrical signal.

4. The optical receiver of claim 1, wherein the pluggable connector includes a pin connector which is configured to mate with a pin connector on the host device when the optical receiver is mounted in the host device.

5. The optical receiver of claim 4, wherein the housing includes a latch which is configured to secure the optical receiver when mounted in the host device.

6. The optical receiver of claim 5, wherein the housing includes a handle which is configured to engage and disengage the latch with the host device.

7. The optical receiver of claim 5, wherein the housing includes an optical connector receptacle configured to connect to an optical fiber.

8. The optical receiver of claim 4, wherein the housing has dimensions of: height at approximately 8.6 mm, width at approximately 13.7 mm, and depth at approximately 56.6 mm.

9. An optical receiver unit, the optical receiver unit comprising:
a plurality of ports, each port being configured to receive an optical receiver, the optical receiver including:
a housing containing:
a photo-detector configured to convert optical signals received through an optical fiber into electrical signals;
an amplifier configured to amplify the electrical signals;
an attenuator configured to attenuate the amplified electrical signals; and
a pluggable connector configured to provide communications between the receiver and a hose device, the communications including the amplified electrical signals.

10. The optical receiver unit of claim 9, wherein the plurality of ports include more than one port.

11. The optical receiver unit of claim 9, wherein the optical receiver includes a microprocessor configured to receive instructions from the optical receiver unit and is configured to control the RF output signal level driver, monitor the input optical power and contains device identification information.

12. The optical receiver unit of claim 9, further comprising a pin connector which is configured to mate with a pin connector on the housing of the optical receiver.

13. The optical receiver unit of claim 10, wherein the housing includes a notch which is configured to mate with a latch on the housing of the optical receiver.

14. The optical receiver unit of claim 9, wherein the housing includes an optical connector receptacle configured to connect to an optical fiber.

15. The optical receiver unit of claim 10, wherein the housing of the optical receiver has dimensions of: height at approximately 8.6 mm, width at approximately 13.7 mm, and depth at approximately 56.6 mm.

16. The optical receiver unit of claim 9, further comprising an RF switching unit configured to select an output amplified electrical signal of a receiver.

17. The optical receiver unit of claim 16, further comprising an RF test port configured to provide a selected output amplified electrical signal from a receiver to an external test device.

18. The optical receiver unit of claim 9, further comprising a controller configured to selectively monitor and control each optical receiver.

19. The optical receiver unit of claim 18, wherein the controller controls amplification and attenuation of electrical signals provided by each receiver.
